(19) United States
(12) Patent Application Publication
(10) Pub. No.: US 2006/0221764 A1
(43) Pub. Date: Oct. 5, 2006

(54) Method and system for preparing input material for structural building blocks

(76) Inventors: Steve Eugene Everett, Austin, TX (US); Jay Dean Everett, Austin, TX (US)

Correspondence Address: DAVID ODELL SIMMONS, 7637 PARKVIEW CIRCLE, AUSTIN, TX, 78731, US

(21) Appl. No.: 11/206,567

(22) Filed: Aug. 18, 2005

Related U.S. Application Data
(60) Provisional application No. 60/662,249, filed on Mar. 17, 2005.

(51) Int. Cl. B01F 15/02

(52) U.S. Cl. 366/193

(57) ABSTRACT

An apparatus for preparing input material for use in a block press includes a homogenizing device, a de-densification device, a liquid additive passage and a plurality of spray heads. The homogenizing device is configured for outputting input material of a prescribed maximum size. The de-densification device is configured for enabling the input material to be reduced from a first bulk density to a second bulk density less than the first bulk density. The de-densification device receives the input material from the homogenizing device. Input material from the de-densification device falls through the liquid additive passage under the gravitational force. The spray heads are exposed within the liquid additive passage for providing a spray of liquid additive within the liquid additive passage whereby the input material is exposed to the spray of liquid additive after being reduced from the first bulk density to the second bulk density.

### CROSS REFERENCE TO RELATED APPLICATIONS

This patent application claims priority to co-pending U.S. Provisional Patent Application having Ser. No. 60/662,249 filed, Mar. 17, 2005, entitled “Materials Conditioner, Mixer, Pulverizer, Solidifier”, having a common applicant herewith and being incorporated herein in its entirety by reference.

### FIELD OF THE DISCLOSURE

The disclosures made herein relate generally to structural building blocks and, more particularly, to methods and systems configured for preparing input material for structural building blocks such as, for example, those consisting of compressed soil, clay and/or aggregate materials.

### BACKGROUND

The formation of building blocks from compaction of materials such as, for example, soil, clay and/or aggregate is a well-known process utilized throughout the world. These types of structural building blocks are commonly and generically referred to as Adobe blocks. Throughout the years, various applications designed to automate this process have been produced. Examples of known equipment configured specifically or similarly for fabricating building blocks by compaction of materials (i.e., conventional building block fabrication equipment) are disclosed in U.S. Pat. Nos. 266,532; 435,171; 3,225,409, 4,640,671, 5,358,760 and 6,224,359.

Materials such as, for example, soil, clay and/or aggregate, which are used for forming structural building blocks, are referred to herein as constituent components of an input material for building block fabrication. On a per-volume basis, constituent components such as, for example, soil, clay and/or aggregate comprise the bulk of such input material from which structural building blocks are made. Compositions such as colorants, fire retardants, binders, fungicides, decontaminants and insecticides are examples of other constituent components, albeit having much smaller volume on a per-unit basis when compared to constituent components such as soil, clay and/or aggregate.

To promote desired strength, density and uniformity in structural building blocks, it is desirable for the input material for such building blocks to be delivered to a block press in a suitable and, preferably, expected and controlled condition. The condition of input material may be characterized by attributes such as, for example, particle size, moisture content and homogeneity. Particle size relates to average particle size for each constituent input material. Moisture content relates to an average volume of liquid content on a per-volume basis. Homogeneity relates to constituent component distribution uniformity on a volume basis (i.e., a relative volume of each constituent component of the input material). By maintaining attributes of input material at desired and/or preferred levels, the structural building blocks made from such input material will exhibit preferred and predictable strength, density and uniformity.

Methods and systems useful for conditioning materials such as soil, clay and aggregate for various purposes are well known. Such methods and systems are referred to herein as conventional methods and systems. However, conventional methods and systems do not independently or jointly teach or render obvious the distinguishing aspects of the present invention, nor are they without shortcomings with respect to the problems that the present invention solves. For example, U.S. Pat. No. 6,422,789 to Brewer discloses a method and apparatus for treatment and remediation of contaminated soils. As clearly disclosed by Brewer, his invention relies upon fluid application to an input material prior to pulverization/conditioning to achieve a desired average particle size, which contributes to shortcomings with respect to preparing input material for use in fabricating structural building blocks. U.S. Pat. Nos. 5,271,694 and 5,342,146 to Cooper each disclose a method and apparatus for treatment of contaminated soils. The inventive approach disclosed by Cooper relies upon non-controlled/non-contained deposition of conditioned input material following the input material being subjected to operations of pulverization and fluid application operations, which contributes to shortcomings with respect to preparing input material for use in fabricating structural building blocks.

Therefore, method and systems configured for promoting known and preferred input material attributes are useful and such systems and methods that overcome shortcomings of conventional method and systems configured for conditioning and/or preparing materials such as, for example, soil, clay and aggregate are advantageous.

### SUMMARY OF THE DISCLOSURE

Embodiments of the present invention relate to preparing input materials for use in a block press for the purpose of making structural building blocks. Methods and apparatuses in accordance with the present invention are specifically configured for promoting known and preferred input material attributes such as, for example, particle size, moisture content and homogeneity. Such methods and apparatuses are particularly useful because native input material (e.g., soil) in some particular geographical region may not exhibit preferred input material attributes, which may adversely impact desired/required structural block properties such as, for example, strength, density and uniformity. Accordingly, the present invention advantageously overcomes one or more shortcomings associated with some native input materials and with conventional approaches and apparatuses configured for processing input materials.

In one embodiment of the present invention, a method comprises a plurality of operations for preparing input material for use in a block press. An operation is performed for de-densifying the input material. An operation is performed for exposing the input material to a spray of liquid additive after the input material is de-densified. Optionally, an operation is then performed for mixing the input material after exposing the input material to the spray of liquid additive.

In another embodiment of the present invention, an apparatus is configured for preparing input material for use in a block press. The apparatus includes an apparatus body having a homogenizing section, a de-densification section and a liquid additive delivery section contained therein. The homogenizing section is configured for outputting input material of a prescribed maximum size. The de-densification section is configured for receiving the input material from the homogenizing section and for enabling the input material to be reduced from a first bulk density to a second bulk density less than the first bulk density. The liquid additive delivery section is configured for receiving the input material from the de-densification section and for enabling the input material to be exposed to a spray of liquid additive after being reduced from the first bulk density to the second bulk density.

In another embodiment of the present invention, an apparatus for preparing input material for use in a block press includes a homogenizing device, a de-densification device, a liquid additive passage and a plurality of spray heads. The homogenizing device is configured for outputting input material of a size not exceeding a prescribed maximum size. The de-densification device is configured for enabling the input material to be reduced from a first bulk density to a second bulk density less than the first bulk density. The de-densification device receives the input material from the homogenizing device. Input material from the de-densification device falls through the liquid additive passage under the gravitational force. The spray heads are exposed within the liquid additive passage for providing a spray of liquid additive within the liquid additive passage whereby the input material is exposed to the spray of liquid additive after being reduced from the first bulk density to the second bulk density.

Turning now to specific aspects of the present invention, in at least one embodiment, the input material is processing such that the input material is of a prescribed maximum size prior to the input material being subjected to said de-densifying and/or is mixed to an adequate degree for enhancing homogeneity.

In at least one embodiment of the present invention, de-densifying the input material includes at least one of enabling the input material to drop under the force of gravity onto a dilution cone structure and mechanically urging the input material from an inner radial position of a de-densification structure to an outer radial position of the de-densification structure.

In at least one embodiment of the present invention, the dilution cone is a multi-level dilution cone structure.

In at least one embodiment of the present invention, de-densifying the input material includes dropping a first portion of the input material onto a first level of the multi-level dilution cone structure and dropping a second portion of the input material onto a second level of the multi-level dilution cone structure.

In at least one embodiment of the present invention, exposing the input material to the spray of liquid additive includes allowing the input material to fall through a passage filled with the spray of liquid additive after performing the de-densifying.

In at least one embodiment of the present invention, the input material is subjected to a heating operation or a cooling operation after either exposing the input material to the spray of liquid additive or mixing the input material.

In at least one embodiment of the present invention, the input material is densified being after being exposed to the spray of liquid additive.

In at least one embodiment of the present invention, densifying the input material includes dropping the input material into a convergent cone structure and/or mechanically urging the input material from an outer radial position of a densification structure to an inner radial position of the densification structure.

In at least one embodiment of the present invention, the apparatus body contains therein a mixing section configured for receiving the input material from the liquid additive delivery section and for mixing at least a portion of the received input material.

In at least one embodiment of the present invention, the apparatus body contains therein a thermal conditioning section configured for receiving the input material from the mixing section and for enabling heat to be added to the input material and/or for enabling heat to be extracted from the input material.

In at least one embodiment of the present invention, the de-densification section includes at least one of a dilution cone structure and a de-densification structure configured for mechanically urging the input material from an inner radial position of the de-densification structure to an outer radial position of the de-densification structure.

In at least one embodiment of the present invention, the liquid additive delivery section includes a passage through which the input material falls and includes one or more spray heads exposed within the passage for providing the spray of liquid additive within the passage.

These and other objects, embodiments advantages and/or distinctions of the present invention will become readily apparent upon further review of the following specification, associated drawings and appended claims.

### BRIEF DESCRIPTION OF THE DRAWINGS

FIG. 1 depicts an embodiment of a method for processing natural material in accordance with the present invention.

FIG. 2 depicts an embodiment of a material conditioning system in accordance with the present invention.

FIG. 3 depicts a first embodiment of a self-contained material conditioning apparatus in accordance with the present invention

FIG. 4 depicts a second embodiment of a self-contained material conditioning apparatus in accordance with the present invention

FIG. 5 is a cross sectional view taken along the line 5-5 in FIG. 4.

### DETAILED DESCRIPTION OF THE DRAWING FIGURES

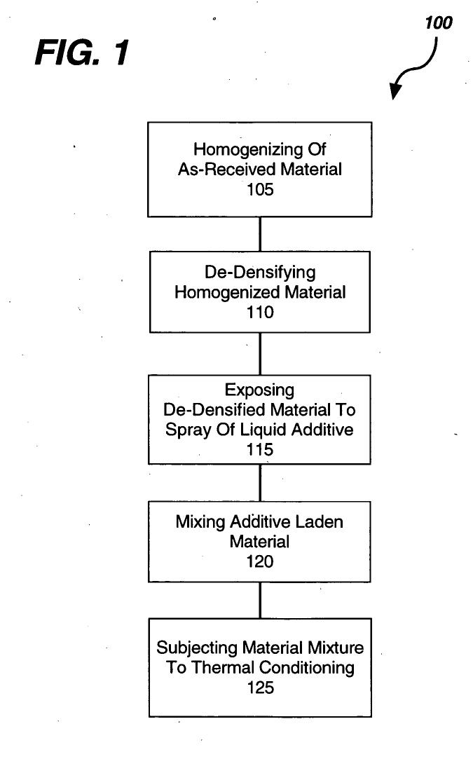

FIG. 1 depicts an embodiment of a method for processing material (e.g., soil, clay, compost, aggregate and the like) in accordance with the present invention. The method for processing material is referred to herein as the method 100. In a preferred embodiment of the present invention, the material being processed in accordance with the method 100 is input material for a block press. Examples of such materials include, but are not limited to, soil, clay, compost, aggregate materials and the like.

The method 100 includes an operation 105 for homogenizing of as-received material (i.e., material). Homogenizing of as-received material accomplished particle sizing and/or mixing of the material, thereby producing a homogenized material (i.e., relatively homogenous material mixture). Examples of techniques for performing such homogenizing of the as-received material include, but are not limited to, pulverizing, shredding, blending, stirring, shearing and chopping. The present invention is not limited to a particular technique for performing such homogenizing of the as-received material. Additionally, it is disclosed herein that a plurality of different techniques for such homogenizing may be implement in combination.

In the case where material is thoroughly mixed prior to being supplied to the method 100, the intent of the operation 105 for homogenizing will be sizing of particles of the material for producing particle-sized material. Particle sizing entails processing the material such that it is of a prescribed maximum size. The objective of this particle sizing is to promote and/or ensure that material that is subsequently processing in accordance with the method 100 is not larger than a prescribed maximum size and to ensure that the material is adequately mixed. For reasons that will be discussed in greater detail below, it is advantageous for the material to not exceed a prescribed maximum size. Particle sizing is advantageous in that it increases accessible surface area of a given volume of the material. For example, a combined surface area of three 1-cubic foot spheres is greater than that of one 3-cubic foot sphere. As is discussed below in greater detail, increased accessible surface area advantageously enables a greater volume of a given volume of material to be acted on directly.

After homogenizing of the material is performed and/or accomplished, an operation 110 is performed for de-densifying the homogenized material thereby producing de-densified material. The de-densification operation entails reducing the density of the homogenized material. Examples of approaches for accomplishing de-densification include, but are not limited to, dropping a given volume of homogenized material onto a surface of a dilution cone structure such that gravity urges the homogenized material from an inner radial position of the dilution cone to an outer, larger radial position of the dilution cone and mechanically urging the homogenized material from an inner radial position of a de-densification structure to an outer radial position of the de-densification structure. De-densification is advantageous in that it for a given volume of material, the average spacing between particles of the material is greater than when exhibiting a relatively high density. As is discussed below in greater detail, the greater average spacing advantageously enables a greater portion of a given volume of material to be acted on directly from a given vantage point of a device (e.g., a liquid spray head).

Next, an operation 115 is performed for exposing the de-densified material to a spray of liquid additive thereby producing additive laden material. Examples of liquid additives include, but are not limited to, water, binding agent, decontaminant, insecticide, fungicide, colorant, and the like. In a preferred embodiment of the present invention, exposing the de-densified material to the spray of liquid additive includes allowing the de-densified material to fall through a passage while generating the spray of liquid additive within the passage. Preferably, the spray of liquid additive is directed to impinge upon the de-densified material as it falls through the passage and/or is generated in a manner such that the spray of liquid is provided within a majority of the passage. As discussed above, the material is particle-sized and de-densified prior to being exposed to the spray of liquid additive. Accordingly, the present invention provides for more uniform distribution of the liquid additive within a given volume of material.

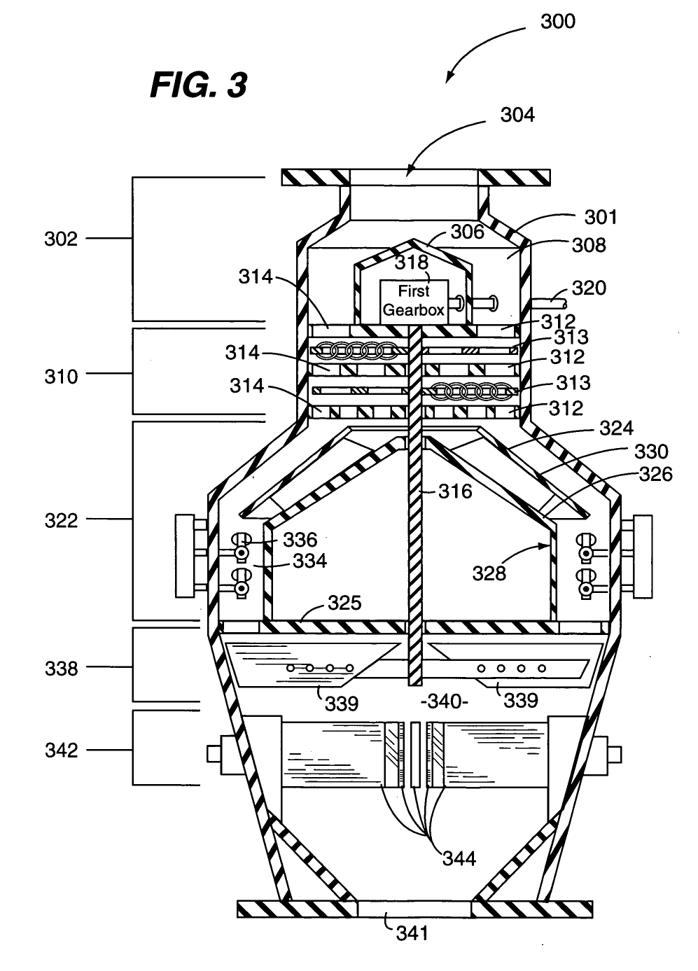

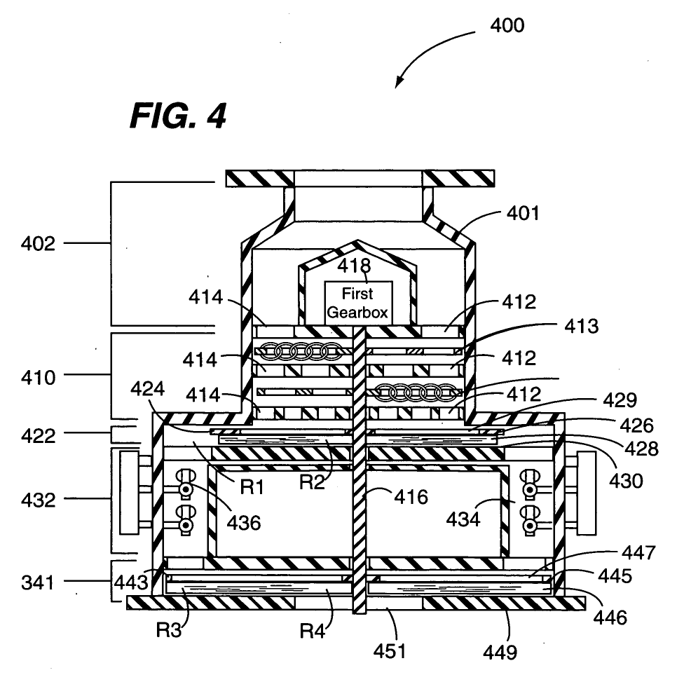

The functionality of creating an additive laden material is an important and distinguishing aspect of the present invention. Mixtures of material that are to be compressed into a block for immediate use without curing time must have a specific amount of liquid content (e.g., water content). Additionally, delivery of the spray of liquid additive to such material for accomplishing such specific amount of liquid content must be delivered in a uniform and repeatable fashion. For example, a material with too much liquid content will typically cause a block leaving a block press to be weak and needing curing time before it can be installed in the wall. Conversely, a material with too little liquid content will typically require increased pressure to hold the particles together. As is discussed below in reference to FIGS. 3 and 4, the present invention may include one or more specific configurations of spray nozzles and liquid delivery techniques for achieving desired liquid content in material.

The additive laden material is then subjected to an operation 120 for mixing the additive laden material such that a material mixture is produced. Through mixing of the additive laden material, distribution of the liquid additive throughout a respective volume of material is accomplished and homogeneity of the material is further promoted. An example of mixing the additive laden material includes agitating (e.g., stirring) the additive laden material with an agitation device (e.g., a plurality of mixing paddles).

Simultaneous with or after mixing the additive laden material or at any time after generating the additive laden material, the material mixture may be subjected to an operation for densifying the material mixture. Examples of facilitating such densification includes dropping the material mixture into a convergent cone structure and mechanically urging the material mixture from an outer radial position of a densification structure to an inner radial position of the densification structure.

Dependent on specific requirements and/or conditions, an operation 125 is performed for subjecting the material mixture to thermal conditioning. Examples of thermal conditioning include, but are not limited to, adding heat to the material mixture and extracting-heat from the material mixture. Examples of requirements and/or conditions in which such thermal conditioning is required include, but are not limited to, the requirement of heating the material mixture in relatively cold ambient conditions, the requirement of cooling the material mixture in relatively hot ambient conditions, adding heat to the material mixture for shortening cure times, adding heat to activate additive liquid components and adding heat to enhance/stimulate performance of additive liquid components.

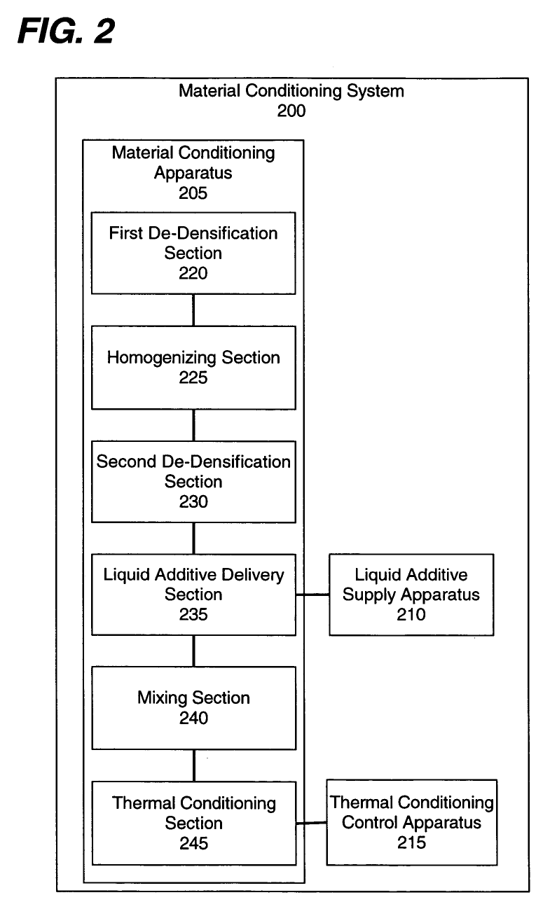

Turning now to FIG. 2, an embodiment of a material conditioning system in accordance with the present invention is depicted, which is referred to herein as the material conditioning system 200. The material conditioning system 200 includes a material conditioning apparatus 205, a liquid additive supply apparatus 210 and a thermal conditioning control apparatus 215. The material conditioning apparatus 205 is configured for enabling methods, operations and/or functionality for processing material in accordance with the present invention to be carried out. The additive supply apparatus 210 is connected to the material conditioning apparatus 205 and is configured for supplying liquid additive to the material conditioning apparatus 205. The thermal conditioning control apparatus 215 is connected to the material conditioning apparatus 205 and is configured for controlling thermal conditioning functionality.

The material conditioning apparatus 205 includes a first de-densification section 220, a homogenizing section 225, a second de-densification section 230, a liquid additive delivery section 235, a mixing section 240 and a thermal conditioning section 245. It is disclosed herein the first de-densification section 220, the homogenizing section 225, the second de-densification section 230, the liquid additive delivery section 235, the mixing section 240 and the thermal conditioning section 245 may be physically interconnected (e.g., within an apparatus body) or may be functionally interconnected while being physically disconnected (e.g., interconnected via a plurality of independent conveyers that transport material between functional sections of the material conditioning apparatus 205).

The first de-densification section 220 receives material from a material source (e.g., one or more hopper apparatuses) and provides for initial de-densification of a material through, preferably, passive means such as a dilution cone that increases the volume of a given amount of material. It should be understood that the present invention is not limited by the means by a particular material source. For example, the material source may provide local proportioning of material components (e.g., through a plurality of hoppers and conveyers) or simply deliver a supply of material that is pre-mixed (e.g., proportioning of material components is performed off-site) or supplied in an unaltered form from a local source (e.g., locally dug soil). It is also disclosed herein that the material may be provided to the first de-densification section 220 at a particular rate that serves to enhance de-densification. For example a relatively lower rate of delivery will enhance de-densification relative to a relatively high rate.

The homogenizing section 225 receives de-densified material from the first de-densification section 220 and provides for homogenizing (e.g., mixing and/or particle-sizing) of that material thus producing homogenized material. The second de-densification section 230 receives homogenized material from the homogenizing section 225 and provides for de-densification of the homogenized material. The liquid additive delivery section 235 receives de-densified material from the second de-densification section 230 and provides for liquid additive delivery.

The liquid additive supply apparatus 210 is connected to the liquid additive delivery section 235 and provides for delivery of the liquid additive to the liquid additive delivery section 235 via one or more spray nozzles or other types of delivery device of the liquid additive delivery section 235. Examples of possible components of the liquid additive supply apparatus 210 include, but are not limited to, liquid storage reservoirs, flow-metering devices, temperature control devices, flow control valves, pumps and tubing. In a preferred embodiment of the liquid additive supply apparatus 210, a plurality of liquid storage reservoirs is provided for having different configurations of liquid additive contained therein. A flow control valve and a pump (i.e., means for inducing flow) are connected between the one or more spray nozzles of the liquid additive delivery section 235 and each one of the storage reservoirs. A flow-metering device (e.g., a programmable logic controller) is connected to each one of the flow control valves and, optionally, to each pump. Optionally, a temperature control device (e.g., a heater or chiller) is connected in a manner such that liquid from at least one of the liquid reservoirs may be heated or cooled relative to ambient conditions prior to being delivered to the one or more spray nozzles.

Still referring to FIG. 2, the mixing section 240 receives additive laden material from the liquid additive delivery section 235 and provides for mixing of the additive laden material. It is disclosed herein that a known mixing arrangement may be used for facilitating such mixing. The thermal conditioning section 245 receives mixed material from the mixing section and provides for thermal conditioning of the mixed material. The thermal conditioning control apparatus 215 is connected to the thermal conditioning section 245 for enabling heat to be added to or extracted from the material mixture. Examples of possible components of the thermal conditioning control apparatus 215 include, but are not limited to, heat exchanges, resistive heating devices, pumps, valves, flow-metering devices and temperature control devices. In a preferred embodiment of the thermal conditioning section 245, thermal transfer elements of the thermal conditioning section 245 are provided within the thermal conditioning section 245 in a manner whereby the material mixture passed over the thermal transfer elements. The thermal transfer elements include resistive heating devices for enabling heat to be added to the material mixture. A temperature controller is connected to the resistive heating devices for enabling a desired amount of heat to be added to the material mixture and/or enabling a desired average material mixture temperature to be attained. Optionally, the thermal conditioning control apparatus may also be configured for extracting heat from the material mixture, such as with the thermal transfer elements being configured with passages for receiving chilled fluid from a heat exchanger apparatus of the thermal conditioning control apparatus 215.

FIG. 3 depicts a first embodiment of a material conditioning apparatus in accordance with the present invention, which is referred to herein as the material conditioning apparatus 300. The material conditioning apparatus 300 includes an apparatus body 301 having a plurality of material processing sections contained therein in a self-contained construction. The self-contained construction of the material conditioning apparatus 300 is advantageous in that it enables for the apparatus to be relatively simple to move, provides for all required components for conditioning natural materials in accordance with the present invention, and can be engaged directly with a block mounting press for ensuring proper input material characteristics regardless of the native characteristics of such input material. A skilled person will appreciate that the material conditioning apparatus 300 is not necessarily limited by the configuration of material delivery apparatuses that supply material to the material conditioning apparatus 300 or by apparatuses that utilized the conditioned material outputted by the material conditioning apparatus 300.

A first de-densification section 302 of the material conditioning apparatus 300 includes a material inlet 304, a dilution cap 306 and a material passage 308. As supplied material is provided through the material inlet 304, the supplied material is directed through the material passage 308 of the first de-densification section 302. As depicted, the material passage 308 of the first de-densification section 302 expands from a first overall cross sectional size adjacent the material inlet 304 to a second overall cross sectional size adjacent the dilution cap 306. The second overall cross sectional size is greater than the first overall cross sectional size, thereby providing for bulk de-densification of the supplied material.

A homogenizing section 310 of the material conditioning apparatus 300 includes a plurality of material flow plates 312 and a plurality of homogenizing devices 313. Each one of the material flow plates 312 is fixedly attached to the apparatus body 301 and includes a plurality of opening 314 therein. The openings 314 of each plate may be the same size, different size, or a combination thereof, depending on the specific objective of the homogenizing section 310. For example, in the three-level flow plate arrangement depicted in FIG. 3, the openings 314 in an uppermost one of the material flow plates 312 are of a relatively large size, the openings 314 in an intermediate one of the material flow plates 312 are of a smaller size than those of the uppermost one of the material flow plates 312 and the openings 314 in a lowermost one of the material flow plates 312 are of a smaller size than those of the intermediate one of the material flow plates 312. In this manner, the material flow plates regulate size of material flowing through the particle-sizing section 310 of the material conditioning apparatus 300.

Each pair of adjacent material flow plates 312 has one of the homogenizing devices 313 positioned therebetween. Optionally, there may be a plurality of homogenizing devices positioned between each adjacent pair of material flow plates 312. The homogenizing devices 313 act on adjacent material for reducing average particle size of the material received from the first de-densification section 302. Examples of the homogenizing devices 313 include, but are not limited to, devices configured for pulverizing natural materials, devices configured for shredding natural materials and devices configured for chopping natural materials. The homogenizing devices 313 are mounted on a first output shaft 316 such that rotation of the first output shaft 316 serves to rotate the homogenizing devices 313 relative to the material flow plates 312, which are stationary. The first output shaft 316 receives power from a first gearbox 318 that is connected to an input power shaft 320 and the input power shaft 320 is connected to a power source such as, for example, a power take-off of an industrial vehicle. In the depicted embodiment, the first gearbox 318 is a right angle gearbox mounted on a top surface of the uppermost material flow plates 312 underneath the dilution cap 306. It is disclosed herein that the uppermost material flow plate 312 may serve solely as a gearbox support frame that provides little or no material flow regulation with respect to size of the material (e.g., includes large non-regulating openings).

A second de-densification section 322 of the material conditioning apparatus 300 includes a multi-level dilution cone structure 324 mounted on a support frame 325 that is fixedly attached to the apparatus body 301. The multi-level dilution cone structure 324 includes a plurality of conical structures over which material may flow. A first conical structure 326 (i.e., a first level of the multi-level dilution cone structure 324) is a top wall of a second dilution cap 328 and has a second conical structure 330 (i.e., a second level of the multi-level dilution cone structure 324) attached thereto. The second conical structure 330 is positioned generally concentric with and above the first conical structure 326. A first portion of the homogenized material drops from the homogenizing section 310 onto the first conical structure 326 of the multi-level dilution cone structure 324 and a second portion of the homogenized material drops onto the second conical structure 330 of the multi-level dilution cone structure 324. In this manner, the multi-level dilution cone structure serves to de-densify the homogenized material received from the homogenizing section 310.

A liquid additive delivery section 332 of the material conditioning apparatus 300 includes a treatment passage 334 through which de-densified material from the second de-densification section 322 falls under the force of gravity. The liquid additive delivery section 332 includes spray nozzles 336 that are positioned within the treatment passage 334 and are configured for providing a spray of liquid additive within the treatment passage 334. In providing the spray of liquid additive within the treatment passage 334, the de-densified material falling through the treatment passage 334 becomes laden with the liquid additive. As discussed above, de-densification and particle sizing in accordance with the present invention advantageously enhances uniform distribution of the liquid additive within a given volume of material.

A mixing section 338 of the material conditioning apparatus 300 includes a plurality of mixing blades 339 attached to the first output shaft 316. The mixing section 338 includes a material collection cavity 340 of the apparatus body 301 that receives additive laden material from the liquid additive delivery section 332 and that includes a material output port 341 through which fully processed material is outputted. The mixing blades 339 reside within the material collection cavity 340 and mix additive laden material after it falls into the material collection cavity 340 from the treatment passage 334 of the liquid additive delivery section 332. Mixing of the additive laden material advantageously serves to enhance uniform distribution of the liquid additive within a given volume of material and to further promote bulk homogeneity of the material. It is disclosed herein that, in an alternate embodiment, the first output shaft 316 provides power to a second gearbox (e.g., located within the first conical structure 326) and that the mixing blades 339 are attached to a second output shaft (i.e., an output shaft of the second gearbox), thereby enabling the homogenizing devices 313 to rotate at a substantially different speed that the mixing blades 339.

A thermal conditioning section 342 of the material conditioning apparatus 300 shares the material collection cavity 340 of the apparatus body 301 with the mixing blades 339 of the mixing section 338. The thermal conditioning section 342 includes a plurality of thermal transfer elements 344 located within the material collection cavity 340. The thermal transfer elements 344 are connected to a thermal transfer control apparatus for enabling heat to be added to and/or extracted from material mixture within the material collection cavity 340.

FIG. 4 depicts a second embodiment of a material conditioning apparatus in accordance with the present invention, which is referred to herein as the material conditioning apparatus 400. The material conditioning apparatus 400 includes an apparatus body 401 having a plurality of material processing sections contained therein in a self-contained construction. The self-contained construction of the material conditioning apparatus 400 is advantageous in that it enables for the apparatus to be relatively simple to move, provides for all required components for conditioning natural materials in accordance with the present invention, and can be engaged directly with a block mounting press for ensuring proper input material characteristics regardless of the native characteristics of such input material. A skilled person will appreciate that the material conditioning apparatus 400 is not necessarily limited by the configuration of material delivery apparatuses that supply material to the material conditioning apparatus 400 or by apparatuses that utilized the conditioned material outputted by the material conditioning apparatus 400.

A first de-densification section 402 of the material conditioning apparatus 300 includes a material inlet 404, a dilution cap 406 and a material passage 408. As supplied material is provided through the material inlet 404, the supplied material is directed through the material passage 408 of the first de-densification section 402. As depicted, the material passage 408 of the first de-densification section 402 expands from a first overall cross sectional size adjacent the material inlet 404 to a second overall cross sectional size adjacent the dilution cap 406. The second overall cross sectional size is greater than the first overall cross sectional size, thereby providing for bulk de-densification of the supplied material.

A particle-sizing section 410 of the material conditioning apparatus 400 includes a plurality of material flow plates 412 and a plurality of homogenizing devices 413. Each one of the material flow plates 412 is fixedly attached to the apparatus body 401 and includes a plurality of opening 414 therein. The openings 414 of each plate may be the same size, different size, or a combination thereof. For example, in the three-level flow plate arrangement depicted in FIG. 4, the openings 414 in an uppermost one of the material flow plates 412 are of a relatively large size, the openings 414 in an intermediate one of the material flow plates 412 are of a smaller size than those of the uppermost one of the material flow plates 412 and the openings 414 in a lowermost one of the material flow plates 412 are of a smaller size than those of the intermediate one of the material flow plates 412. In this manner, the material flow plates regulate size of material flowing through the particle-sizing section 410 of the material conditioning apparatus 400.

Each pair of adjacent material flow plates 412 has one of the homogenizing devices 413 positioned therebetween. Optionally, there may be a plurality of homogenizing devices positioned between each adjacent pair of material flow plates 412. The homogenizing devices 413 act on adjacent material for reducing average particle size of the material received from the first de-densification section 402. Examples of the homogenizing devices 413 include, but are not limited to, devices configured for pulverizing natural materials, devices configured for shredding natural materials and devices configured for chopping natural materials. The homogenizing devices 413 are mounted on a first output shaft 416 such that rotation of the first output shaft 416 serves to rotate the homogenizing devices 413 relative to the material flow plates 412, which are stationary. The first output shaft 416 receives power from a first gearbox 418 that is connected to an input power shaft 420 and the input power shaft 420 is connected to a power source such as, for example, a power take-off of an industrial vehicle. In the depicted embodiment, the first gearbox 418 is a right angle gearbox mounted on a top surface of the uppermost material flow plates 412 underneath the dilution cap 406. It is disclosed herein that the uppermost material flow plate 412 may serve solely as a gearbox support frame that provides little or no material flow regulation with respect to size of the material (e.g., includes large non-regulating openings).

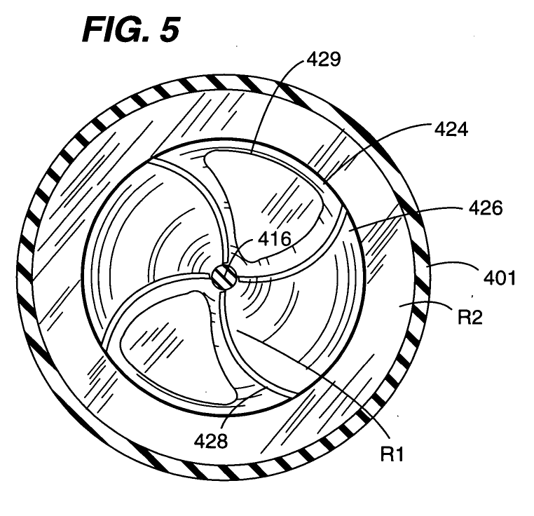

A second de-densification section 422 of the material conditioning apparatus 400 includes a mechanical de-densification structure. The mechanical de-densification structure includes a de-densification wiper assembly 424 having a structural body 426 fixedly attached to the first output shaft 416 and a plurality of de-densification wipers 428 attached to the structural body 426. The output shaft turns the de-densification wiper assembly 424 clockwise as viewed in FIG. 5. De-densified material that falls through openings 429 in the structural body 426 onto a de-densification metering plate 430 of the second de-densification section 422 is engaged by the de-densification wipers 428 as the de-densification wiper assembly 424 turns. As depicted in FIG. 5, the de-densification wipers 428 have a profiled shape that is configured for mechanically urging the homogenized material from an inner radial position R1 of the mechanical de-densification structure to an outer radial position R2 of the mechanical de-densification structure. In doing so, the volume of a given mass of material is increased, thus reducing its density.

A liquid additive delivery section 432 of the material conditioning apparatus 400 includes a treatment passage 434 through which de-densified material from the second de-densification section 422 falls under the force of gravity. The liquid additive spray section 432 includes spray nozzles 436 that are positioned within the treatment passage 434 and are configured for providing a spray of liquid additive within the treatment passage 434. In providing the spray of liquid additive within the treatment passage 434, the de-densified material falling through the treatment passage 434 becomes laden with the liquid additive. As discussed above, de-densification and particle sizing in accordance with the present invention advantageously enhances uniform distribution of the liquid additive within a given volume of material.

A densification section 441 of the material conditioning apparatus 400 includes a mechanical densification structure. The mechanical densification structure includes a densification wiper assembly 443 having a structural body 445 fixedly attached to the first output shaft 416 and a plurality of densification wipers 446 attached to the structural body 445. The first output shaft 416 turns the densification wiper assembly 443. Overall construction of the densification wiper assembly 443 is generally the same as the de-densification wiper assembly 424. De-densified material that falls through openings 447 in the structural body 445 onto a densification metering plate 449 of the second de-densification section 422 is engaged by the densification wipers 446 as the densification wiper assembly 443 turns. Assuming that the densification wiper assembly 443 turns in the same direction as the de-densification wiper assembly and that the densification wipers 446 of the densification wiper assembly 443 have an opposite curvature as the curvature of the de-densification wipers 428, the densification wipers 446 will have the effect of mechanically urging the additive laden material from an outer radial position R3 of the mechanical densification structure to an inner radial position R4 of the mechanical de-densification structure. In doing so, the volume of a given mass of material is deceased, thus increasing its density. Optionally a reducer/reverser gearbox may be attached between the mechanical densification structure of the densification section 441 and the first output shaft 416 for reversing the direction of rotation the densification wiper assembly 443 with respect to the de-densification wiper assembly 424. The densification metering plate 449 includes outlet opening 451 through which densified material is outputted. It is disclosed herein that, depending on specific requirements and conditions, the degree of de-densification may be greater than the degree of densification, vise-versa, or approximately the same.

The present invention is not limited by a particular spray head configuration. However, certain spray head configurations will advantageously affect delivery of the liquid additive. As disclosed herein (e.g., in FIGS. 3 and 4), a material conditioning apparatus in accordance with the present invention may include a plurality of spray nozzles at a plurality of locations around the perimeter of the treatment passage of the liquid additive delivery section. In preferred embodiments of the present invention, the spray nozzles at each spray location are individually connected to liquid supply apparatuses in a manner enabling spray of liquid additive through a first portion of the nozzles to be selectively operable relative to a second portion of the nozzles. In this manner, the number of active spray nozzles may be adjusted to achieve a desired rate of delivery of liquid additive and/or to enable selective delivery rates of different types of liquid additives.

In a preferred embodiment, the spray nozzles are configured such that there is a plurality of vertically spaced-apart rings of nozzles. It is disclosed herein that there may be rings located adjacent an inner surface of the treatment passage of the liquid additive delivery section and/or adjacent an outer surface of the treatment passage of the liquid additive delivery section. In this embodiment, each ring of nozzles is individually operable such that the number of active rings and the location of such active rings can be adjusted to achieve a desired rate of delivery of liquid additive, thereby resulting in a wide range of liquid delivery possibilities.

It is disclosed herein that control of liquid delivery in the liquid additive delivery section can be implemented manually or in an automated. For example, one or more liquid content sensors may be incorporated in a material conditioning in accordance with the present invention for enabling average liquid content of the additive laden material to be determined. It is further disclosed herein that determining such average liquid content may include determining a liquid content in the as-received or de-densified material and determining a liquid content in the additive laden material. Alternatively, determining liquid content may be limited to only determining a liquid content in the additive laden material. Examples of locations for such one or more liquid content sensors include, but are not limited to, the first de-densification section, the densification section, the liquid additive delivery section, mixing section and the densification section.

As disclosed herein, precise control of liquid content in material is an important aspect of the present invention. Accordingly, it is important for the spray of liquid additive from each nozzle to be provided in a known manner. To this end, it is disclosed herein that means for limiting adverse effect of debris on delivery of liquid additive is advantageous. Examples of a means for cleaning debris from the spray nozzles includes brushes vertically mounted on the mixing blades 339 in FIG. 3 and on the densification wiper assembly 443 in FIG. 4. The length and placement of such brushes is such that they engage the nozzles to provide a cleaning action (i.e., brushing action). An example of a means for limiting-adverse affect of debris on the spray characteristics is a shroud being provided on each spray nozzle for limiting direct contact for the spray nozzle with material falling past the spray nozzles.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method, comprising:
de-densifying input material;
exposing said input material to a spray of liquid additive after de-densifying said input material

2. The method of claim 1, further comprising:
processing said input material for accomplishing at least one of said input material being of a prescribed maximum size prior to said input material being subjected to said de-densifying and mixing of said input material for enhancing homogeneity of said input material.

3. The method of claim 2, further comprising:
mixing said input material after exposing said input material to the spray of liquid additive.

4. The method of claim 1 wherein said de-densifying includes at least one of enabling said input material to drop under the force of gravity onto a dilution cone structure and mechanically urging said input material from an inner radial position of a de-densification structure to an outer radial position of the de-densification structure.

5. The method of claim 4 wherein:
the dilution cone is a multi-level dilution cone structure; and
said de-densifying includes dropping a first portion of said input material onto a first level of said multi-level dilution cone structure and dropping a second portion of said input material onto a second level of said multi-level dilution cone structure.

6. The method of claim 1 wherein said exposing input material to the spray of liquid additive includes allowing said input material to fall through a passage filled with the spray of liquid additive after performing said de-densifying.

7. The method of claim 1, further comprising:
subjecting the input material to one of a heating operation and a cooling operation after one of exposing said input material to the spray of liquid additive and mixing said input material.

8. The method of claim 1, further comprising:
densifying said input material after exposing said input material to the spray of liquid additive, wherein said densifying includes at least one of dropping said input material into a convergent cone structure and mechanically urging said input material from an outer radial position of a densification structure to an inner radial position of the densification structure.

9. The method of claim 1, further comprising:
processing said input material for accomplishing at least one of said input material being of a prescribed maximum size prior to said input material being subjected to said de-densifying and mixing of said input
material for enhancing homogeneity of said input material; and
mixing said input material after exposing said input material to the spray of liquid additive;
wherein said de-densifying includes mechanically urging said input material from an inner radial position of a de-densification structure to an outer radial position of the de-densification structure;
wherein said exposing input material to the spray of liquid additive includes allowing said input material to fall through a passage filled with the spray of liquid additive after performing said de-densifying.

10. An apparatus, comprising:
an apparatus body having a plurality of material processing sections contained therein, wherein the apparatus body contains therein:
a homogenizing section configured for outputting input material of at least one of a prescribed maximum size and prescribed degree of homogeneity;
a de-densification section configured for receiving said input material from the homogenizing section and for enabling said input material to be reduced from a first bulk density to a second bulk density less than the first bulk density; and
a liquid additive delivery section configured for receiving said input material from the de-densification section and for enabling said input material to be exposed to a spray of liquid additive after being reduced from the first bulk density to the second bulk density.

11. The apparatus of claim 10 wherein the apparatus body contains therein a mixing section configured for:
receiving said input material from the liquid additive delivery section; and
mixing said input material.

12. The apparatus of claim 10 wherein the apparatus body contains therein a thermal conditioning section configured for:
receiving said input material from said mixing section; and
enabling at least one of heat being added to said input material and heat being extracted from said input material.

13. The apparatus of claim 10 wherein the de-densification section includes at least one of a dilution cone structure and a de-densification structure configured for mechanically urging said input material from an inner radial position of the de-densification structure to an outer radial position of the de-densification structure.

14. The apparatus of claim 13 wherein the dilution cone structure is a multi-level dilution cone structure.

15. The apparatus of claim 10 wherein the liquid additive delivery section includes:
a passage through which said input material falls; and
at least one spray head exposed within the passage for providing the spray of liquid additive within the passage.

16. The apparatus of claim 10 wherein:
the apparatus body contain therein a mixing section configured for receiving said input material from the liquid additive section and for mixing said input material and contains therein a thermal conditioning section configured for receiving said input material from said mixing section and for enabling at least one of heat being added to said input material and heat being extracted from said input material;
the de-densification section includes at least one of a dilution cone structure and a de-densification structure configured for mechanically urging said input material from an inner radial position of the de-densification structure to an outer radial position of the de-densification structure; and
the liquid additive delivery section includes a passage through which said input material falls and at least one spray head exposed within the passage for providing the spray of liquid additive within the passage.

17. An apparatus, comprising:
a homogenizing device configured for outputting input material of at least one of a prescribed maximum size and a prescribed degree of homogeneity;
a de-densification device configured for enabling said input material to be reduced from a first bulk density to a second bulk density less than the first bulk density, wherein the de-densification device receives said input material from the homogenizing device;
a liquid additive passage through which said input material from the de-densification device falls under the force of gravity; and
at least one spray head exposed within the liquid additive passage for providing a spray of liquid additive within the liquid additive passage whereby said input material is exposed to the spray of liquid additive after being reduced from the first bulk density to the second bulk density

18. The apparatus of claim 17, further comprising:
a densification device configured for enabling said input material to be increased from a third bulk density to a fourth bulk density greater than the third bulk density, wherein the densification device receives said input material from within the liquid additive passage.

19. The apparatus of claim 18 wherein:
the de-densification device include at least one of a dilution cone structure and a de-densification structure configured for mechanically urging said input material from an inner radial position of the de-densification structure to an outer radial position of the de-densification structure; and
the densification device includes at least one of a convergent cone structure and a densification structure configured for mechanically urging said input material from an outer radial position of a densification structure to an inner radial position of the densification structure.

20. The apparatus of claim 19 herein the de-densification device and the densification device each include a rotating structure having a plurality of vanes extending from a major face thereof.
